(19) United States
(12) Patent Application Publication
(10) Pub. No.: US 2025/0215352 A1
(43) Pub. Date: Jul. 3, 2025

(54) PRIMARY OR SECONDARY ALCOHOL-INITIATED NONIONIC SURFACTANT AND USE THEREOF, DETERGENT COMPOSITION AND LIQUID LAUNDRY PRODUCT COMPRISING THE SAME

(71) Applicants: Dow Global Technologies LLC, Midland, MI (US); Rohm and Haas Company, Collegeville, PA (US)

(72) Inventors: Cheng Shen, Shanghai (CN); Wanglin Yu, Pearland, TX (US); Yang Zhang, Shanghai (CN); Aslin Izmitli, Spring City, PA (US); Dan Jiang, Shanghai (CN)

(21) Appl. No.: 18/850,252

(22) PCT Filed: Apr. 15, 2022
(86) PCT No.: PCT/CN2022/087041

§ 371 Date: Sep. 24, 2024

(51) Int. Cl. C11D 1/83; C11D 1/22; C11D 1/29; C11D 1/722; C11D 17/04

(52) U.S. Cl. CPC C11D 1/83; C11D 1/22; C11D 1/29; C11D 1/722; C11D 17/043; C11D 2111/12

(57) ABSTRACT

The present disclosure relates to a primary or secondary alcohol-initiated nonionic surfactant, which has formula (I): Where R′ is selected from the group consisting of a linear primary alcohol moiety having C16-18 alkyl chain or a secondary alcohol moiety having C8-18 alkyl chain; R″ is methyl or ethyl group; x is an integer selected from 2 to 4; y is an integer selected from 1 to 25; and z is an integer selected from 1 to 50. The primary or secondary alcohol-initiated nonionic surfactant provides a remarkable combination of good detergency and improved viscosity controlling at highly concentrated and unit-dose detergent formulations, and lower foaming property.

### FIELD The present disclosure relates to a primary or secondary alcohol-initiated nonionic surfactant and use thereof, detergent composition and liquid laundry product comprising the same.

### BACKGROUND

With increasing awareness on sustainable development, a highly concentrated and unit-dose detergent formulation is a clear market trend in both home care and industrial cleaning applications. In the highly concentrated and unit-dose detergent formulation, a total surfactant contents could reach around 50%-70% by weight or even higher, which makes saving on packaging materials, less water in production and transportation, etc. However, a high surfactant content may cause the formulation with high viscosity and difficulty in handling and use, prolong its dissolution time in cold water, cause gel formation during its dissolution, and consequently increase energy consumption in cleaning.

Generally, the highly concentrated detergent formulations mainly contain anionic surfactants, nonionic surfactants, some organic solvents, and other ingredients, Despite good detergency of the anionic surfactants in cleaning, the popular anionic surfactants, such as AES (alcohol ether sulfate, particularly sodium laureth sulfate) and LAS (linear alkylbenzene sulfonate), often form a gel at high concentration (30-70% by weight). Therefore, the organic solvents are added into the formulations to reduce viscosity and maintain its handling property. However, the organic solvents would not bring equivalent detergency as the surfactants. In contrast, they increase the cost of the formulations and would likely cause odor issues. Linear primary alcohol ethoxylate (e.g., L-PAE-9) is the most popular nonionic surfactant, and it indeed offers good detergency performance among the commercially available nonionic surfactants, but its water solution at high concentration of 30-60% by weight is also a gel. In consequence, L-PAE-9 in the highly concentrated or unit-does detergent formulations would also increase the viscosity. Branched alcohol initiated alkoxylated nonionic surfactants, such as ECOSURF™ EH-9 and LUTENSOL® XL-80, are flowable at a high concentration in water (e.g., in a concentration of 40-60% by weight). They have been broadly used in the highly concentrated or unit-dose detergent formulations as viscosity controller, but their detergency is weaker compared with L-PAE-9.

Therefore, there is still an urgent request for cleaning customers to have nonionic surfactants which can offer a remarkable combination of good detergency and strong viscosity controlling in the highly concentrated and unit-dose detergent formulations. In addition, if a good viscosity reduction can help the formulators decrease the solvent amount, this will be an interesting and welcome performance. Besides, low foaming formulations are often preferred in the Industrial & Institutional (I&I) cleaning; and in home care cleaning, this turns to be a need as well, because high foaming may extend rinsing time and increase water consumption. In the surfactant selection criteria, the biodegradability also becomes a required property for cleaning customers.

### SUMMARY

After persistent exploration, the inventors have surprisingly developed a primary or secondary alcohol-initiated nonionic surfactant, as well as a detergent composition and a liquid laundry product comprising the same, which exhibits good detergency, improved viscosity controlling (i.e., better flowability and no gel being formed during its dissolution in water) at highly concentrated and unit-dose detergent formulations, and lower foaming property (i.e., quick foam collapse).

In a first aspect of the present disclosure, the present disclosure provides a primary or secondary alcohol-initiated nonionic surfactant, which has the formula (I):

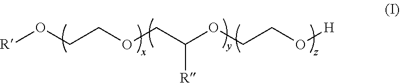

Where R′ is selected from the group consisting of a linear primary alcohol moiety having a C16-18 alkyl chain or secondary alcohol moiety having a C8-18 alkyl chain; R″ is a methyl or ethyl group; x is an integer selected from 2 to 4; y is an integer selected from 1 to 25; and z is an integer selected from 1 to 50.

In a second aspect of the present disclosure, the present disclosure provides use of the primary or secondary alcohol-initiated nonionic surfactant in a detergent composition.

In a third aspect of the present disclosure, the present disclosure provides a detergent composition, comprising:
(a) at least one anionic surfactant; and
(b) the primary or secondary alcohol-initiated nonionic surfactant;
wherein components (a) and (b) are in amount of at least 50% by weight based on the total weight of the detergent composition.

In a forth aspect of the present disclosure, the present disclosure provides a liquid laundry product comprising the detergent composition.

In the present disclosure, the primary or secondary alcohol-initiated nonionic surfactant as well as the detergent composition and liquid laundry product comprising the surfactant may exhibit improved detergency, good viscosity controlling at highly concentrated and unit-dose detergent formulations, and lower foaming property. Further, they also exhibit better flowability and would not form gel when being dissolved in water.

It is to be understood that both the foregoing general description and the following detailed description are exemplary and explanatory only and are not restrictive of the invention, as claimed.

### BRIEF DESCRIPTION OF THE DRAWINGS

FIG. 1 is a Comparison of Ross-Miles foam height of Examples IE-1 to IE-4 and Comparative Examples CE-A and CE-B in the present disclosure.

FIG. 2 is a Comparison of detergency (soil removal) in highly concentrated liquid laundry detergent formulation of Examples IE-1 to IE-4 and Comparative Examples CE-B, CE-C and CE-D in the present disclosure.

FIG. 3 is a Comparison of detergency (soil removal) in unit-dose laundry detergent formulation (a/b=60/40 by weight) of Examples IE-1 to IE-4 and Comparative Examples CE-B, CE-D, CE-E and CE-F in the present disclosure.

FIG. 4 is a Comparison of viscosity in unit-dose laundry detergent formulation (a/b=60/40 by weight) of Examples IE-1 to IE-4 and Comparative Examples CE-A, CE-B, CE-C and CE-F in the present disclosure.

FIG. 5 is a Comparison of viscosity in unit-dose laundry detergent formulation (a/b=70/30 by weight) of Examples IE-1 to IE-4 and Comparative Examples CE-A, CE-B, CE-C and CE-F in the present disclosure.

### DETAILED DESCRIPTION

Unless defined otherwise, all technical and scientific terms used herein have the same meaning as commonly understood by one of ordinary skill in the art to which the invention belongs. As disclosed herein, “and/or” means “and, or as an alternative” or “additionally or alternatively”. All ranges include endpoints unless otherwise indicated.

In the present disclosure, the primary or secondary alcohol-initiated nonionic surfactant has the formula (I):

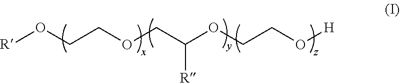

where R′ is selected from the group consisting of a linear primary alcohol moiety having C16-18 alkyl chain or a secondary alcohol moiety having C8-18 alkyl chain; R″ is methyl or ethyl group; x is an integer selected from 2 to 4; y is an integer selected from 1 to 25; and z is an integer selected from 1 to 50.

The term “C16-18 alkyl chain” herein refers to alkyl chain having from 16 to 18 carbon atoms; and the term “C8-18 alkyl chain” herein refers to alkyl chain having from 8 to 18 carbon atoms. In an embodiment of the present disclosure, the C16-18 alkyl chain in the linear chain can be selected from n-hexadecyl, n-heptadecyl, n-octadecyl or mixture thereof.

In an embodiment of the present disclosure, the secondary alcohol comprises, but not limited to, 2-octanol, 3-octanol, 4-octanol, 2-nonanol, 3-nonanol, 4-nonanol, 5-nonanol, 2-decanol, 3-decanol, 4-decanol, 5-decanol, 2-undecanol, 3-undecanol, 4-undecanol, 5-undecanol, 6-undecanol, 2-dodecanol, 3-dodecanol, 4-dodecanol, 5-dodecanol, 6-dodecanol, 2-tridecanol, 3-tridecanol, 4-tridecanol, 5-tridecanol, 6-tridecanol, 7-tridecanol, 2-tetradecanol, 3-tetradecanol, 4-tetradecanol, 5-tetradecanol, 6-tetradecanol, 7-tetradecanol, 2-pentadecanol, 3-pentadecanol, 4-pentadecanol, 5-pentadecanol, 6-pentadecanol, 7-pentadecanol, 8-pentadecanol, 2-hexadecanol, 3-hexadecanol, 4-hexadecanol, 5-hexadecanol, 6-hexadecanol, 7-hexadecanol, 8-hexadecanol, 2-heptadecanol, 3-heptadecanol, 4-heptadecanol, 5-heptadecanol, 6-heptadecanol, 7-heptadecanol, 8-heptadecanol, 2-octadecanol, 3-octadecanol, 4-octadecanol, 5-octadecanol, 6-octadecanol, 7-octadecanol, 8-octadecanol, 9-octadecanol, or any combinations thereof.

In an embodiment of the present disclosure, the secondary alcohol comprises 2-dodecanol, 3-dodecanol, 4-dodecanol, 5-dodecanol, 6-dodecanol, 2-tridecanol, 3-tridecanol, 4-tridecanol, 5-tridecanol, 6-tridecanol, 7-tridecanol, 2-tetradecanol, 3-tetradecanol, 4-tetradecanol, 5-tetradecanol, 6-tetradecanol, 7-tetradecanol or any combinations thereof.

In an embodiment of the present disclosure, x is an integer selected from 2, 3 and 4. In an embodiment of the present disclosure, y is an integer selected from 1 to 25, from 1 to 20, from 1 to 16, from 1 to 12, from 1 to 9, from 1 to 4, from 4 to 25, from 4 to 20, from 4 to 16, from 4 to 12, from 4 to 9, from 9 to 25, from 9 to 20, from 9 to 16, from 9 to 12, from 12 to 25, from 12 to 20, from 12 to 16, from 16 to 25, from 16 to 20, and from 20 to 25. In an embodiment of the present disclosure, z is an integer selected from 1 to 50, from 1 to 40, from 1 to 30, from 1 to 20, from 1 to 10, from 1 to 5, from 5 to 50, from 5 to 40, from 5 to 30, from 5 to 20, from 5 to 10, from 10 to 50, from 10 to 40, from 10 to 30, from 10 to 20, from 20 to 50, from 20 to 40, from 20 to 30, from 30 to 50, from 30 to 40 and from 40 to 50.

In an alternative embodiment of the present disclosure, the sum of x and z is an integer selected from 3 to 54, from 3 to 50, from 3 to 40, from 3 to 30, from 3 to 20, from 3 to 10, from 3 to 5, from 5 to 54, from 5 to 50, from 5 to 40, from 5 to 30, from 5 to 20, from 5 to 10, from to 54, from 10 to 50, from 10 to 40, from 10 to 30, from 10 to 25, from 10 to 20, from 10 to 15, from 15 to 54, from 15 to 50, from 15 to 40, from 15 to 30, from 15 to 25, from 15 to 20, from 20 to 54, from 20 to 50, from 20 to 40, from 20 to 30, from 20 to 25, from 25 to 54, from 25 to 50, from 25 to 40, from 25 to 30, from 30 to 54, from 30 to 50, from 30 to 40, from 40 to 10 54, from 40 to 50, and from 50 to 54.

In an alternative embodiment of the present disclosure, the number of y is less than that of the sum of x and z. Alternatively, y may be equal to the sum of x and z, or y may be greater than the sum of x and z. In an alternative embodiment of the present disclosure, y is equal or greater than 8, 12, 16 or 20. In an alternative embodiment of the present disclosure, the sum of x and z is greater than 20, 24, 28 or 32.

In the present disclosure, the linear C16-18 primary alcohol or C8-18 secondary alcohol initiated triblock nonionic surfactants can increase the total surfactant concentration in the detergent formulations to a level which is much higher than that in the prior art, and the concentration of anionic surfactant in the detergent composition can also be increased to a level which is much higher than that in the prior art. In this regards, the inventors may apply the primary or secondary alcohol-initiated nonionic surfactant to a detergent composition comprising anionic surfactants, so as to increase the total surfactant concentration and reduce solvent content. In the present disclosure, the detergent composition is characterized by reduced solvent content, increased surfactant content, low viscosity, quicker dissolution, good detergency, improved viscosity controlling (i.e., better flowability and no gel being formed) at highly concentrated and unit-dose detergent formulations, and lower foaming property (i.e., quick foam collapse). or a combination of two or more thereof.

In the present disclosure, the detergent composition may comprise (a) at least one anionic surfactant; and (b) at least one primary or secondary alcohol-initiated nonionic surfactant. In the present disclosure, the detergent composition may further comprise (c) at least one organic solvent.

In an embodiment of the present disclosure, the anionic surfactants to be used in the present invention as the component (a) includes alkylsulfates, alkyl ether sulfates, alkylsulfonates, fatty acid salts, dialkylsulfosuccinates, alkylbenzenesulfonates, alkylphosphate, fatty acid soaps, and α-olefinsulfonates, though it is not particularly limited. The anionic surfactants are preferably selected from among alkylsulfates, alkyl ether sulfates, alkylbenzenesulfonates, alkanesulfonates, fatty acid salts, dialkylsulfosuccinates and any combinations thereof. In an embodiment of the present disclosure, the anionic surfactants are substantially free of any intermediate polarity spacers inserted between a hydrophilic moiety and a hydrophobic moiety of the anionic surfactants. In the present disclosure, the intermediate polarity spacers generally comprise chain of propylene oxide (PO), chain of butylene oxide (BO) or any combination of ethylene oxide (EO), PO and BO in block or random order.

As to the optional organic solvents, they may be used alone in the detergent composition, or used in combination with other organic solvents in the detergent composition. In an embodiment of the present disclosure, the organic solvents may be at least one solvent selected from the group of alcohols, glycols, and glycol ethers, for example, ethanol, isopropyl alcohol, propylene glycol and etc.

In an embodiment of the present disclosure, components (a) and (b) are in amount of at least 50% by weight, at least 60% by weight, at least 70% by weight or at least 80%, based on the total weight of the detergent composition.

In an embodiment of the present disclosure, component (a) is in amount of at least 50% by weight, at least 60% by weight, at least 70% by weight or at least 80% by weight of the sum of components (a) and (b).

In an embodiment of the present disclosure, the detergent composition comprises less than 20% by weight, less than 15% by weight, less than 10% by weight, less than 5% by weight, or less than 1% by weight of component (c).

In the present disclosure, the detergent composition can be diluted with water to provide a liquid laundry product. In the present disclosure, the detergent composition can contain some water, and the amount of water may be adjusted according to actual need of cleaning. In one embodiment of the present disclosure, the amount of water is generally low for highly concentrated detergent formulation. On the other hand, the unit-dose detergent formulation generally cannot contain too much water, since the packaging material of the unit-dose detergent formulation is water soluble. For example, the unit-dose detergent formulation may comprise 5-10% by weight of water.

The present disclosure provides nonionic surfactants which may deliver the following properties:
Good detergency;
Good viscosity controlling at highly concentrated and unit-dose formulations;
Low foam or quick foam collapse; and
Good product safety profile.

Besides remarkable combination of detergency and viscosity controlling in the highly concentrated and unit-dose detergent formulations, it can effectively reduce the solvent usage in the formulation, which meets the sustainable development trend and helps formulators reduce formulation cost.

### EXAMPLES

Some embodiments of the invention will now be described in the following examples, wherein all parts and percentages are by weight unless otherwise specified.

The information of the raw materials used in Examples is listed in the following Table 1:

TABLE 1
Raw materials used in Examples

| Raw material | Description | Supplier |
|---|---|---|
| Tergitol ™ 15-S-3 | C12-14 secondary alcohol ethoxylate | DOW |
| C16-18 alcohol | C16/C18 alcohol mixing ratio | P&G |
| | at about 50/50 by weight | |
| Aqueous solution of | Alkoxylation catalyst | Sigma- |
| potassium hydroxide | | Aldrich |
| in 45-50% wt. | | |
| Acetic acid | Neutralizing agent after | Sigma- |
| | alkoxylation | Aldrich |
| Ethylene oxide | Building block | Dow |
| Propylene oxide | Building block | Dow |

### Synthesis Examples

The nonionic surfactants in the present disclosure can be obtained in conventional manners by reacting an alcohol with alkylene oxides, such as ethylene oxide (EO) and propylene oxide (PO), in the presence of a catalyst. Polymerization can be bulk polymerization or solution polymerization. Catalysts suitable for polymerization of alkylene oxide can be found in literature, for example F. E. Bailey, Jr., Joseph V. Koleske, “Alkylene Oxides and Their Polymers” Marcel Dekker, New York, 1991, p. 35, including anionic or basic catalysts, acid or cationic catalysts, and coordinate catalysts, for example, postassium hydroixde (KOH), boron trifluoride, or double metal cyanide complex (DMC) catalysts such as zinc hexacyanocobaltate. The alkylene oxides are typically fed into a reactor containing dried initiator and the catalyst at temperatures varying from 50 to 160° C. When the pressure in the reactor returns to approximately the same pressure before feeding the alkylene oxides, the polymerization is usually considered complete. The catalysts can be neutralized, removed by known means, for example filtration, adsorption, and ionic exchange, or left in the products depending on the products and applications.

### Synthesis Example 1: Synthesis of Nonionic Surfactant Represented by the Formula: L-C-(EO)₄—(PO)₁₄-(EO)₅, Where L-C₁₆₋₁₈ Refer to a Linear C₁₆₋₁₈ Moiety

1. 1 mole of L-C₁₆₋₁₈ alcohol and aqueous solution of potassium hydroxide (45-50% wt.) were charged into the reactor. The KOH content was added at around 0.17% wt. based on the weight of end product.
2. The mixture was kept heating at around 50-60° C. for 30 min.
3. The moisture was controlled less than 1000 ppm after vacuum stripping at about 80° C., then the mixture was kept around 110-140° C.
4. Then, a first portion of EO in 4 moles (corresponding to 4 molar equivalents of L-C16-18 alcohol) was fed into the reactor slowly.
5. When the pressure in the reactor returned to approximately same as the pressure before EO feeding, PO in 14 moles (corresponding to 14 molar equivalents of L-C₁₆₋₁₈ alcohol) was fed into the reactor slowly and the reactor temperature was kept at 110-140° C.
6. When the pressure in the reactor returned to approximately same as the pressure before PO feeding, the last portion of EO in 5 moles (corresponding to 5 molar equivalents of L-C₁₆₋₁₈ alcohol) was fed into the reactor slowly at 110-140° C.
7. When the pressure in the reactor returned to approximately same as the pressure before EO feeding, the reaction was maintained at 110-140° C. for 2 more hours to ensure a full consumption of EO.
8. After the N₂ purge to remove residual oxide, the reactor cooled down to around 60° C. at ambient pressure. Then, acetic acid was added into the reactor to neutralize the KOH catalyst.

9. After cooling down to around 40° C., the desired product was obtained.

### Synthesis Example 2: Synthesis of Nonionic Surfactant Represented by the Formula: L-C₁₆₋₁₈-(EO)₄—(PO)₁₄-(EO)₁₅, Where L-C₁₆₋₁₈—Refer to a Linear C₁₆₋₁₈—Moiety

Synthesis Example 2 was conducted similar to synthesis example 1, except that in step 6,the last portion of EO in 15 moles (corresponding to 15 molar equivalents of L-C₁₆₋₁₈ alcohol) was fed into the reactor slowly.

### Synthesis Example 3: Synthesis of Nonionic Surfactant Represented by the Formula: L-C₁₆₋₁₈-(EO)₄—(PO)₁₄-(EO)₂₅, Where L-C₁₆₋₁₈—Refer to a Linear C₁₆₋₁₈—Moiety

Synthesis Example 3 was conducted similar to synthesis example 1, except that in step 6, the last portion of EO in 25 moles (corresponding to 25 molar equivalents of L-C₁₆₋₁₈ alcohol) was fed into the reactor slowly.

### Synthesis Example 4: Synthesis of Nonionic Surfactant Represented by the Formula: Sec-C₁₂₋₁₄-(EO)₃—(PO)₁₀-(EO)₁₀, Where Sec-C ₁₂₋₁₄—Refer to a Secondary C₁₂₋₁₄—Moiety

Synthesis Example 4 was conducted similar to synthesis example 1, except that TERGITOL™ 15-S-3 was used, instead of L-C₁₆₋₁₈ alcohol; step 4 was omitted since TERGITOL™ 15-S-3 already contains 3 moles of EO in each molecule; in step 5, PO in 10 moles (corresponding to 10 molar equivalents of TERGITOL™ 15-S-3) was fed into the reactor slowly and in step 6, the last portion of EO in 10 moles (corresponding to 10 molar equivalents of TERGITOL™ 15-S-3) was fed into the reactor slowly.

### Inventive Examples 1-4 and Comparative Examples A-F

As shown in Table 2, the surfactants in Inventive Examples (IE) 1-4 and Comparative Examples (CE) A-F were tested or evaluated according to the measurements described below.

TABLE 2

| Example # | Sample description |
|---|---|
| IE-1 | L-C₁₆₋₁₈-(EO)₄-(PO)₁₄-(EO)₅ |
| IE-2 | L-C₁₆₋₁₈-(EO)₄-(PO)₁₄-(EO)₁₅ |
| IE-3 | L-C₁₆₋₁₈-(EO)₄-(PO)₁₄-(EO)₂₅ |
| IE-4 | Sec-C₁₂₋₁₄-(EO)₃-(PO)₁₀-(EO)₁₀ |
| CE-A | L-C₁₂₋₁₄-(EO)₇ |
| CE-B | L-C₁₂₋₁₄-(EO)₉ |
| CE-C | L-C₁₂₋₁₄-(PO)₈-(EO)₉ |
| CE-D | 2-ethylhexyl-(PO)₅-(EO)₉ |
| CE-E | 2-ethylhexyl-(PO)₅-(EO)₆-(PO)₃ |
| CE-F | 2-propylheptyl-(PO)₁₋₂-(EO)₈ |

TABLE 3
Comparison of Basic Surfactant Properties

| | Cloud point | | Ross-Miles | Surface | |
|---|---|---|---|---|---|
| | (° C., | Pour | foam height | tension (mN/m, | |
| | 1% wt. | point | (mm, 0.1% wt., | 0.1% wt., | CMC |
| Sample | aq. soln.) | (° C.) | aq. soln.)^{b} | aq. soln.) | (ppm) |
| IE-1 | 28 | −12 | 59/13 | 33.3 | 6.6 |
| IE-2 | 54 | 12.5 | 79/37 | 35.3 | 15.2 |
| IE-3 | 78 | 26 | 74/35 | 37.1 | 18.0 |
| IE-4 | 46 | 4.5 | 95/16 | 32.8 | 42.6 |
| CE-A | 57 | 17 | 95/84 | 29 | 16 |
| CE-B | 79 | 20 | 110/100 | 29 | 25 |
| CE-C | 40 | 8 | 79/20 | 31.3 | 6 |
| CE-D | 64^{a} | 16 | 85/8 | 31 | 1066 |
| CE-E | 35 | −42 | 0/0 | 32 | 315 |
| CE-F | 56 | 10 | 106/11 | 27 | 436 |

^{a}Cloud point data was measured at 10% wt. aqueous solution.
^{b}Foam heights at 0 and 5 minutes.

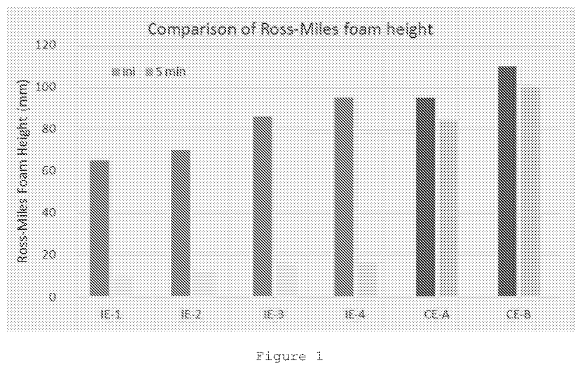

As shown in Table 3, all the four Inventive Examples IE-1, IE-2, IE-3 and IE-4 had low CMC values, which could bring good surfactant efficiency. The Ross-Miles foam heights in Table 3 and FIG. 1 showed all the four Inventive Examples IE-1, IE-2, IE-3 and IE-4 delivered medium initial foam height and very quick foam collapse, which were much quicker than the CE-A and CE-B based on the linear C₁₂₋₁₄ alcohol ethoxylate. In most industrial applications, low foam and quick foam collapse are desired. In FIG. 1, the vertical bar on the left in each Inventive Examples IE-1, IE-2, IE-3 and IE-4 as well as Comparative Examples CE-A and CE-B represents an initial foam height; and the vertical bar on the right in each Inventive Examples IE-1, IE-2, IE-3 and IE-4 as well as Comparative Examples CE-A and CE-B represents a foam height in the end of 5 min.

### Preparation of Detergent Formulation

Highly concentrated liquid laundry detergent formulations were formulated according to the following steps:
1. Water and propylene glycol was mixed in a beaker with mechanical stirring.
2. Dodecylbenzene sulfonic acid (DBSA), sodium laureth-2 sulfate (AES), oleic acid and KOH were added into the beaker.
3. One of the nonionic surfactants of IE-1, IE-2, IE-3 and IE-4 as well as CE-B to CE-D was added into the beaker and the mixture was blended homogeneously.
4. The pH of the mixture was adjusted to 8.0-8.5 with KOH to form highly concentrated liquid laundry detergent compositions.

TABLE 4
Highly concentrated liquid laundry detergent formulation

| Ingredient | Content (% wt.) |
|---|---|
| Oleic acid | 5.0 |
| DBSA | 11.0 |
| AES (70%) | 12.0 |
| nonionic surfactants | 24.0 |
| Propylene glycol | 6.0 |
| KOH | 3.2 |
| Water | 38.8 |

Different Inventive Examples (IE) 1-4 and Comparative Examples (CE) B-D as “nonionic surfactant” were evaluated in the highly concentrated liquid laundry detergent formulation.

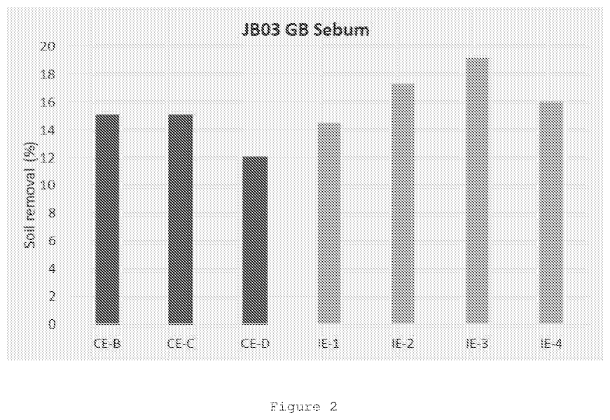

As shown in FIG. 2, the detergency results showed the inventive triblock surfactant IE-1 and IE-4 had similar detergency as CE-B & CE-C, and IE-2 and IE-3 showed slightly better detergency than CE-B & CE-C based on linear C₁₂₋₁₄ alcohol initiated ethoxylate or alkoxylate, and much improved detergency than CE-D based on branched fatty alcohol initiated alkoxylate.

### Unit-Dose Laundry Liquid Detergent Formulation

Unit-dose laundry liquid detergent formulations were formulated according to the following steps:
1. Water and propylene glycol was mixed in a beaker with mechanical stirring.
2. Dodecylbenzene sulfonic acid (DBSA), sodium laureth-2 sulfate (AES), oleic acid and monoethanolamine (MEA) were added into the beaker.
3. One of the nonionic surfactants of IE-1, IE-2, IE-3 and IE-4 as well as CE-B to CE-E was added into the beaker and the mixture was blended homogeneously.
4. The pH was adjusted to 7.5 with MEA to form the unit-dose liquid laundry detergent compositions.

TABLE 5
Unit-dose laundry detergent formulation

| | a/b = 60/40* | | | a/b = 70/30* | |
|---|---|---|---|---|---|
| Anionic | 48.01 | AES (70%) | 23.7 | 55.97 | 28.9 |
| surfactants (a) | | DBSA | 16.6 | | 20.2 |
| | | oleic acid | 10.0 | | 10.0 |
| | | Monoethanolamine | 4.82 | | 5.54 |
| | | (MEA) | | | |
| Nonionic | 32.0 | | 32.0 | 24.0 | 24.0 |
| surfactants (b) | | | | | |
| Solvent | | Propylene glycol | 10.0 | | 10.0 |
| Water | | | 2.88 | | 1.36 |
| Sum | | | 100.0 | | 100.0 |

*a/b = weight of total anionic surfactants/weight of total nonionic surfactants

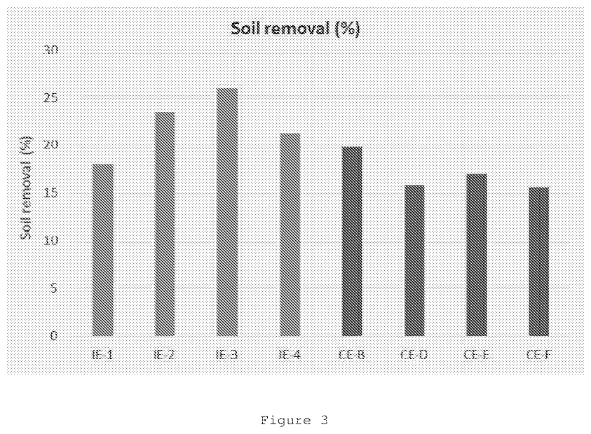

The formulations in Table 5 contained very high total surfactant contents at about 80% by weight in the unit-dose laundry formulations. The solvent amount (propylene glycol) and water content were at 10% by weight and 10% by weight (due to AES (70%) containing water as well), respectively. In addition, the formulation contained very high content of anionic surfactants at 60% or 70% based on the total weight of the surfactants. In the formulation with anionic/nonionic surfactant at 60/40 by weight, the IE-2/IE-3 demonstrated higher detergency, compared with the CEs, as shown in FIG. 3.

### Viscosity Comparison in Highly Concentrated Formulation

Original formulation in the viscosity controlling study

TABLE 6
Highly concentrated laundry detergent formulation

| Ingredient | Content (% wt.) |
|---|---|
| Oleic acid | 5.0 |
| DBSA | 11.0 |
| AES | 12.0 |
| L-PAE-9 | 16.0 |
| Nonionic surfactant | 8.0 |
| Propylene glycol | 6.0 |
| KOH | 3.2 |
| Water | 38.8 |

TABLE 7
Formulation viscosity results

| Nonionic | | |
|---|---|---|
| surfactant^{#} | Viscosity (cP at 20° C.) | Viscosity (cP at 5° C.) |
| IE-1 | 355 | 850 |
| IE-2 | 400 | 1140 |
| IE-3 | 455 | 1120 |
| IE-4 | 371 | 855 |
| CE-B | 840 | 2180 (not stable*) |
| CE-C | 623 | 1404 |
| CE-D | 479 | 1530 |
| CE-F | 470 (not stable*) | — |

^{#}Nonionic surfactant used in formulation of Table 6.
*“not stable”: phase separation of hazy appearance was observed after overnight storage at room temperature.

TABLE 8
Modified formulation in the viscosity
controlling study (solvent-free)

| Ingredient | Content (% wt.) |
|---|---|
| Oleic acid | 5.0 |
| DBSA | 11.0 |
| AES | 12.0 |
| Nonionic surfactant | 24.0 |
| MEA | 3.4 |
| Water | 44.6 |

Compared with the formulation in Table 6, the formulation in Table 8 didn't contain any solvent (propylene glycol), which could be more challenging to maintain the formulation with a good flowability. In addition, L-PAE-9 was also replaced and included in “Nonionic surfactant”. On evaluating different IEs and CEs as “nonionic surfactant”, we measured the formulation viscosities at 2 different temperatures (5° C. and 20° C.) and the results are listed in Table 9.

TABLE 9
Formulation viscosity results (solvent-free)

| Nonionic | | |
|---|---|---|
| surfactant^{#} | Viscosity (cP at 20° C.) | Viscosity (cP at 5° C.) |
| IE-1 | 295 | 905 |
| IE-2 | 425 | 1236 |
| IE-3 | 485 | 1352 |
| IE-4 | 310 | 770 |
| CE-C | 2500 | Gel |
| CE-D | 503 | 1360 |
| CE-F | Not stable* | — |

^{#}Nonionic surfactant used in formulation of Table 8.
*“not stable”: phase separation of hazy appearance was observed.

Based on the data in Table 7 and Table 9, it was found that in the highly concentrated liquid laundry detergent formulation, the 4 inventive surfactants always offered the formulations with lower viscosity than the comparative surfactants. Also, the formulation stability with IEs was more stable. In addition, such a performance advantage could be more interesting at low temperature, which could be beneficial in low temperature storage.

### Viscosity Measurement in Dissolution of Unit-Dose Laundry Detergent Formulation

The formulations with CEs and IEs were prepared according to Table 5. Then, the viscosity of the formulation before and after dilution with different amounts of water was measured. For an unit-dose laundry formulation, if it forms a gel during dissolution, it will slow down its dissolution and consequently affect its detergency.

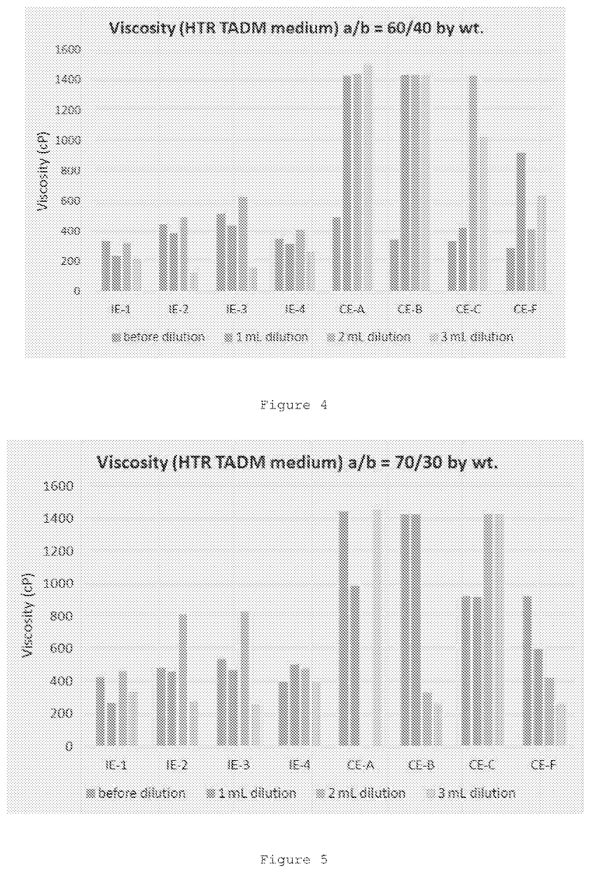

As shown in FIGS. 4 and 5, the Inventive Examples in the unit-dose detergent formulations resulted in low viscosities before dilution and after dilution in water. In contrast, the formulations of Comparative Examples exhibited much higher viscosity. Therefore, the good viscosity controlling properties of IEs are demonstrated in the unit-dose detergent formulations with low water and low solvent contents. In FIGS. 4 and 5, the 1^{st} to 4^{th} vertical bars from the left in each Inventive Examples IE-1, IE-2, IE-3 and IE-4 as well as Comparative Examples CE-A, CE-B, CE-C and CE-F represent a viscosity before dilution, a viscosity after dilution with 1 mL deionized water, a viscosity after dilution with 2 mL deionized water, and a viscosity after dilution with 3 mL deionized water, respectively.

### Testing and Evaluation

### Ross-Miles Foam Height Test According to GB/T 7462-94 Foaming Test

0.1% wt. active aqueous solution of surfactant was prepared with DI water.
The Ross-Miles test tube was rinsed with DI water, and sample solution.
50 mL of the sample solution was poured into the test tube.
Once no foaming was observed for this first 50 mL of sample solution, 200 mL of sample solution was added via a dropping pipette.
The tap of dropping pipette was open, and the solution flew down.
Once the flow of the solution was over, the initial foam height was recorded as the initial one.
In the end of 5 min, the foam height was recorded as the final one.

### Surface Tension and CMC Measurement

Surface tension was measured on KRUSS Force Tensiometer K100C. The whole test was conducted at room temperature,
An aqueous solution of a surfactant at 1% wt. active content as mother solutions and water as blank solution were prepared, respectively.
The surfactant mother solution was gradually added into the water at a known amount.
The surface tension at different surfactant concentrations were recorded.
Surface tension values were plotted against concentration and CMC was determined from the break point of the plot.

### Cloud Point Measurement

1. A water solution of triblock nonionic surfactant (concentration at 1% wt.) was prepared by weighing 0.5 g sample into 49.5 mL of distilled water.
2. The mixture was kept stirring until a full dissolution of the surfactant in water; then, 10 mL of the prepared solution was poured into the test tube; and a thermometer was put in the test tube.
3. The test tube was heated in a water bath set at a given temperature.
4. Once the test solution became cloudy, the temperature was recorded.
5. The Step 3-4 was repeated for three times, and the average value was considered as the cloud point.

### Pour Point Measurement

The test procedure was referred to ASTM D97-12 with the equipment YuTong (YT-S10E-3). The test procedure included the steps described as here below:
1. The sample (≈45 mL) was poured into the test jar to the level mark.
2. The sample was put in the equipment with a kerosene thermometer for temperature measurement,
3. The equipment was on and a pre-determined temperature value was set.
4. Once the set temperature was reached and stable, a visual check of the sample fluidity was conducted. The observation didn't exceed 5 sec.
5. The set temperature was decreased every 3° C. When the temperature was close to the estimated pour point, the temperature adjustment was reducing to every 1° C.
6. The lowest temperature at which the sample was flowable could be recorded as its pour point.
7. The measurement was repeated for 3 times to record the average as the final pour point.

### Soil Removal Test of Concentrated Liquid Laundry Detergent Formulations

Washing process:
Equipment: Terg-o-tometer JB003—Sebum cloth
Dosage: 0.8 g/L
Water hardness: 250 ppm calculated by CaCO3 (weight ratio—MgC126H2O:CaC12=20.37:16.7)
Temperature: 30° C.
Rotation speed: 120 rpm

### GB Sebum Contains Synthetic Sebum, Gum Pigment/Cotton, Supplied by China Research Institute of Daily Chemical Industry

1. Soil removal measurement:
   Equipment: Konica Minolta spectrophotometer CM-3600A.
2. Procedure:
   The color of dry swatches was measured by the spectrophotometer before and after washing. Each piece was measured on both sides and readings were averaged. The output of color measurement included L*, a* and b*. Detergency was calculated based on the following formula:
   Soil removal (%)=(L*after−L*before)/(96−L*before)*100%

### Viscosity Controlling Measurement

Formulation viscosity was measured with Brookfield LVDV-II. The samples with viscosity lower than 1000 were conducted by #62 spindle at 30 rpm; the ones with viscosity higher than 1000 were measured by #62 spindle at 10 rpm.

### Viscosity Measurement During Dissolution

2 mL unit dose formulations were added into 8 mL glass tubes. The initial viscosity was measured by High throughput TADM method which is a pressure-based parallel viscosity measurement method developed by Dow. It estimates the viscosity of samples by monitoring pressure change in a pipette. After viscosity measurement, 1 mL deionized water was added into the tubes and the mixtures were mixed until homogeneous. Then, their viscosity was measured by TADM method again. The process of water addition and viscosity measurement was repeated two times until 3 mL deionized water was mixed into unit dose formulations.

Based on all the above performance comparison, the triblock nonionic surfactants of the present invention exhibited unique and interesting surfactant properties: low CMC, medium foam with quick foam collapse. The evaluations in different types of detergent formulations showed these triblock nonionic surfactants delivered an exceptional combination of detergency and viscosity controlling, none of the comparative benchmark was able to offer such a good balanced performance. More particularly and interestingly, the inventive triblock nonionic surfactants containing unit-dose detergent formulations exhibiting low solvent and water contents could keep better flowability in the dissolution stage and improved detergency.

1. (canceled)

2. (canceled)

3. (canceled)

4. (canceled)

5. A detergent composition, comprising:
(a) at least one anionic surfactant; and
(b) a primary or secondary alcohol-initiated nonionic surfactant of the formula (I): 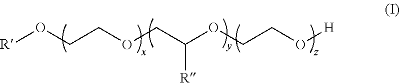
where R′ is selected from the group consisting of a linear primary alcohol moiety having a C16-18 alkyl chain or a secondary alcohol moiety having a C8-18 alkyl chain; R′ is a methyl or ethyl group; x is an integer from 2 to 4; y is an integer from 1 to 25; and z is an integer from 1 to 50
wherein components (a) and (b) are in amount of at least 50% by weight based on the total weight of the detergent composition.

6. The detergent composition according to claim 5, wherein components (a) and (b) are in amount of at least 70% by weight based on the total weight of the detergent composition.

7. The detergent composition according to claim 5, wherein component (a) is in amount of at least 50% by weight of the sum of components (a) and (b).

8. The detergent composition according to claim 5, wherein the detergent composition further comprises (c) an organic solvent.

9. The detergent composition according to claim 8, wherein the detergent composition comprises less than 20% by weight of component (c).

10. The detergent composition according to claim 5, wherein the anionic surfactant is selected from alkylsulfates, alkyl ether sulfates, alkanesulfonates, fatty acid salts, alkylbenzenesulfonates, dialkylsulfosuccinates and any combinations thereof.

11. A liquid laundry product comprising the detergent composition according to claim 5.

12. A single unit dose laundry product comprising the detergent composition according to claim 5.

13. The detergent composition according to claim 5, wherein the primary or secondary alcohol-initiated nonionic surfactant has a structure in which y is an integer from 9 to 25; and the sum of x and z is an integer from 5 to 30.

14. The detergent composition according to claim 5, wherein the primary or secondary alcohol-initiated nonionic surfactant has a structure in which y is an integer from 9 to 16; and the sum of x and z is an integer from 5 to 20.

15. The detergent composition according to claim 5, wherein component (a) is in amount of at least 70% by weight of the sum of components (a) and (b).
